(19) United States
(12) Patent Application Publication
(10) Pub. No.: US 2026/0339166 A1
(43) Pub. Date: Oct. 29, 2026

(54) LIGHT STEERING ASSEMBLY FOR OPTICAL IMAGE STABILIZATION, AND OPTICAL SYSTEM

(71) Applicant: NINGBO SUNNY OPOTECH CO., LTD, Zhejiang (CN)

(72) Inventor: Liang ZHOU, Zhejiang (CN)

(73) Assignee: NINGBO SUNNY OPOTECH CO., LTD, Zhejiang (CN)

(21) Appl. No.: 19/115,918

(22) PCT Filed: Sep. 15, 2023
(86) PCT No.: PCT/CN2023/119067

§ 371 Date: Mar. 27, 2025

(30) Foreign Application Priority Data
Sep. 28, 2022 (CN) 202211192343.3
Sep. 28, 2022 (CN) 202211192966.0
Sep. 28, 2022 (CN) 202211192969.4

(51) Int. Cl. G03B 13/34; G02B 7/04; G02B 13/00; G02B 27/64; G03B 5/00; H04N 23/54; H04N 23/55; H04N 23/57

(52) U.S. Cl. CPC G03B 13/34; G02B 7/04; G02B 13/0065; G02B 27/646; G03B 5/00; H04N 23/54; H04N 23/55; H04N 23/57; G03B 2205/0069

(57) ABSTRACT

A light steering assembly for optical image stabilization, and an optical system. The optical system comprises: a base (11), a light steering assembly (20) and a lenses assembly (30), wherein the base (11) comprises a base side wall (112) and a base bottom surface (113); the light steering assembly (20) comprises a first supporting mechanism (21) arranged on the base (11) and supported by the base bottom surface (113), a second supporting mechanism (22) mounted on the first supporting mechanism (21), a reflecting member (23) mounted on the second supporting mechanism (22), and a first driving portion (24) for providing a driving force for the reflecting member (23), the first driving portion (24) comprising a first driving assembly (241) and a second driving assembly (242), the first driving assembly (241) being configured to drive the reflecting member (23) to move around a second rotation axis, and the second driving assembly (242) being configured to drive the reflecting member (23) to move around a first rotation axis; and the lenses assembly (30) is arranged on a light emergent side of the light steering assembly (20) and comprises: at least one lenses portion (31), one lenses carrier (32) and one second driving portion (33), the second driving portion (33) driving the lenses carrier (32) so as to drive the lenses portion (31) to move in the direction of an optical axis.

### TECHNICAL FIELD

The present application relates to the technical field of camera modules, and in particular to a light steering assembly for optical image stabilization, and an optical system.

### BACKGROUND ART

Recently, due to the development of mobile communication technology, portable terminals such as smart phones have become popular, and miniaturized and lightweight camera modules have emerged. Therefore, at least one camera module is configured on a portable terminal body. Customers' design demands for camera modules are increasing day by day. Users not only require that the camera modules configured on mobile terminals have high capacity and high performance, but also require the development of camera modules that meet the standards of digital cameras (DSLR). The development of camera modules must meet the development trend of miniaturization and lightness while maintaining high performance and high capacity.

The periscope camera module reflects the light beam incident to the front end of the camera module by placing a reflective prism at the front end to change the direction of the light, and then reaches the photosensitive chip after passing through the lens assembly and the color filter, so that the camera module can be installed horizontally in the electronic device, thereby ensuring that the telephoto camera module can reduce the height of the telephoto camera module while satisfying the long-focus shooting effect. Therefore, the periscope camera module can largely achieve the requirements of miniaturization of terminal equipment and optical zoom by changing the angle of the incident light, reasonably changing the longer lens structure, and reducing the module height.

The camera module uses a motor to realize the optical autofocus function (hereinafter referred to as the focus or zoom function, autofocus), zoom function and optical image stabilization function (hereinafter referred to as the anti-shake function: optical image stabilization) during the shooting process. The focus or zoom function refers to the function of adjusting the focus by linearly moving the lens system in the optical axis direction through a motor, focusing on the subject, and producing a clear image at the image sensor (CMOS, CCD, etc.) located at the rear of the lens. The anti-shake function is a technology that compensates for image blur due to shaking during shooting by controlling the motor anti-shake. The image sensor captures the light entering through the lens system and converts it into an image signal.

The addition of focus or zoom function, and anti-shake function makes the driving structure of the camera module more complicated. In addition, the camera module needs to be equipped with corresponding actuators, which on one hand increases the size of the camera module, while the installation space reserved for the camera module is also limited; and on the other hand, the increase in the driving structure increases the weight of the lens and other components, requiring a greater driving force to achieve, which increases the energy consumption of the module drive. In addition, the complexity of the camera module driving structure makes the assembly of the various components of the camera module more difficult, and increases the process cost.

### SUMMARY

As to the above problems, the present application provides a light steering assembly and an optical system, which realize optical image stabilization through the light steering assembly and realize focus or zoom through a lens assembly of the optical system, so that the optical system can be installed in an internal space of a predetermined shell, and meet the requirements of miniaturization while realizing image stabilization function and focus or zoom function.

One object of the present application is to provide a light steering assembly and an optical system, which realizes an anti-shake function by driving a reflective member through a first driving portion that does not include a lens and has a relatively low weight, and realizes a focusing or zooming function through a lens assembly, thereby significantly reducing the overall power consumption of the optical system.

One object of the present application is to provide a light steering assembly and an optical system, wherein optical image stabilization is achieved through the light steering assembly, and a lens assembly only realizes the focus or zoom function but does not perform the image stabilization function, so that the structural components can be reduced in a single lens module, thus the height dimension of the lens assembly is smaller, thereby reducing the height of a camera module.

One object of the present application is to provide a light steering assembly and an optical system, wherein the lens assembly does not comprise a driving assembly for anti-shake, thereby having a relatively low weight, and a second driving portion provides sufficient driving force to a lens portion, thereby achieving low-power drive.

One object of the present application is to provide a light steering assembly and an optical system. By adopting an integrally formed base, a first supporting mechanism, a first holding element and a first driving assembly of the light steering assembly are at least partially provided on the base bottom surface, and a second holding element is also provided near the bottom side of the base. This can facilitate assembly in the case of an integrally formed base, while effectively accommodating the driving assembly and supporting or retaining the first and second holding elements, thereby achieving miniaturization.

One object of the present application is to provide a light steering assembly and an optical system, driving resistance of rotation around a second rotation axis is reduced by configuring at least one of the first groove and the second groove to be a groove shape that is compatible with the first holding element in a cross section perpendicular to the second rotation axis.

One object of the present application is to provide a light steering assembly and an optical system, wherein a line connecting a sphere centers of at least two first holding elements constitutes the second rotation axis, and the first holding element rolls in situ around the second rotation axis in the first groove, guiding the first supporting mechanism and other components supported by it to rotate relative to the base around the second rotation axis, thereby achieving low-power driving of a large rotation angle.

One object of the present application is to provide a light steering assembly and an optical system, wherein the first holding element rolls in situ around the second rotation axis in a space formed by the first groove and the second groove, to drive a first supporting mechanism and the components supported by it to rotate around the second rotation axis, thereby achieving large-angle rotation adjustment through small displacements, and at the same time being able to provide sufficient driving force within a limited space, thereby improving driving efficiency.

One object of the present application is to provide a light steering assembly and an optical system, wherein at least one of a third groove and a fourth groove is provided with a groove shape extending around the first rotation axis or a groove shape extending along the optical axis (Z axis) and being in a cross section perpendicular to the optical axis (Z axis), thereby reducing the resistance to rotation around the first rotation axis.

One object of the present application is to provide a light steering assembly and an optical system, wherein the second holding element is a spherical member, and the third groove is configured as a hemispherical groove based on the spherical member, and a part of the fourth groove is a trapezoidal groove and a part of it is a planar groove, and a part of the second holding element can roll in the hemispherical third groove to achieve low-power rotational motion in the plane.

One object of the present application is to provide a light steering assembly and an optical system, wherein a second holding element rolls in situ in the hemispherical third groove in a direction parallel to a first rotation axis, to guide the second supporting mechanism and other components supported by it to rotate around the first rotation axis as the center of rotation, with a rotation radius being half of the line connecting the sphere centers of at least two second holding elements, thereby realizing rotational motion within a plane.

One object of the present application is to provide a light steering assembly and an optical system, wherein at least one of a first groove and a second groove opposite to each other is configured with a shape in which the width along a cross section parallel to an XY plane decreases as the depth increases, and at least one of a third groove and a fourth groove opposite to each other is configured with a shape in which the width along a cross section parallel to the XY plane decreases as the depth increases, so that the movement of the first supporting mechanism and the components supported by it around the second rotation axis driven by the first holding element and the movement of the second supporting mechanism and the components supported by it around the first rotation axis driven by the second holding element do not interfere with each other.

One object of the present application is to provide a light steering assembly and an optical system, wherein the first rotation axis and the second rotation axis are on the same cross section and intersect each other perpendicularly, to prevent one layer of a holding element from interfering with another layer of the holding element when the holding element rotates.

One object of the present application is to provide a light steering assembly and an optical system, wherein the sphere centers of the first holding element and a part of the second holding element are located on the same XY cross-section, to prevent the rotational movement of one layer of holding elements from interfering with the movement of another layer of the holding elements.

One object of the present application is to provide a light steering assembly and an optical system, wherein the first holding element and the second holding element are offset from each other along the X-axis direction (height direction), to reduce the thickness of the first supporting mechanism, thereby reducing the height of the light steering assembly and realizing miniaturization and thinness of the camera module.

One object of the present application is to provide a light steering assembly and an optical system, wherein the first holding element rolls in situ around the second rotation axis in the space formed by the first groove and the second groove, and is provided at the first layer, thereby greatly reducing the driving energy consumption of the driving assembly.

One object of the present application is to provide a light steering assembly and an optical system, wherein upper side and lower side surfaces of a single driving magnet are respectively provided with a first magnetic attraction member and a second magnetic attraction member to clamp two layers of holding elements respectively. The two layers of holding elements are stacked in the height direction, and can be assembled based on an integrally formed base, making assembly convenient.

One object of the present application is to provide a light steering assembly and an optical system, wherein the upper side and lower side surfaces of a single driving magnet are respectively provided with a first magnetic attraction member and a second magnetic attraction member to respectively clamp two layers of holding elements, thereby reducing structural members, making the structure compact and simple, and reducing the weight of the driving portion for the optical image stabilization, and while achieving miniaturization, sufficient driving force is provided to the reflective member to achieve image stabilization.

One object of the present application is to provide a light steering assembly and an optical system, wherein at least one of a fifth groove and a sixth groove is configured to have a groove shape that is compatible with the third holding element in a cross section perpendicular to the Z axis, thereby reducing driving resistance.

One object of the present application is to provide a light steering assembly and an optical system, wherein a groove-shaped groove structure is shared by a single-sided third holding elements, thereby simplifying the structure of the lens carrier, reducing the weight of the lens carrier, reducing power consumption, and at the same time increasing the focusing travel distance of the lens carrier and the lens portion.

One object of the present application is to provide a light steering assembly and an optical system, wherein the third holding element rolls in situ in the hemispherical fifth groove with high precision and a stable motion mechanism, and has little impact on the “tilt” during the movement of the lens carrier along the optical axis, thereby making the imaging more stable.

One object of the present application is to provide a light steering assembly and an optical system, in which the focus or zoom magnetic attraction assembly is offset from the third driving magnet and is offset from the third holding element in the YZ plane direction (horizontal direction), so as to reserve space for the movement of the third holding element.

One object of the present application is to provide a light steering assembly and an optical system, wherein a focus or zoom magnetic attraction assembly indirectly generates attraction with a third driving magnet to clamp the third holding element, and by providing an additional magnetic conductive sheet and through magnetization, it interacts with the focus or zoom magnetic attraction assembly located on the base bottom surface, thereby leaving sufficient space for the third holding element and the sixth groove of the lens carrier and the fifth groove on the base bottom surface.

To achieve the above objectives, according to one aspect of the present application, provided is a light steering assembly for optical image stabilization, which comprises:
a base having a base bottom surface;
a first supporting mechanism supported on the base bottom surface;
a second supporting mechanism supporting a reflecting member and provided on the first supporting mechanism; and
a first driving portion comprising a first driving assembly and a second driving assembly, wherein the second driving assembly drives the second supporting mechanism and the components supported by it to rotate around a first rotation axis, and the first driving assembly is used to drive the first supporting mechanism and the components supported by it to rotate around a second rotation axis;
a magnetic attraction assembly comprising at least one first magnetic attraction member and at least one second magnetic attraction member, wherein the first magnetic attraction member is provided at the base bottom surface, and the second magnetic attraction member is provided at the second supporting mechanism;
wherein the first driving assembly comprises at least one first driving magnet provided at the first supporting mechanism, and the first magnetic attraction member and the second magnetic attraction member are respectively provided at the upper and lower side surfaces of the first driving magnet.

In some examples, the first driving assembly comprises at least one first driving coil, and the first driving coil is provided between the first magnetic attraction member and the first driving magnet and is opposite to the first driving magnet, to drive the first supporting mechanism and the components supported by it to rotate around the second rotation axis.

In some examples, the second magnetic attraction member is provided at a lower side surface of the second supporting mechanism and is opposite to the first driving magnet.

In some examples, the second driving assembly comprises at least one second driving magnet and a second driving coil, which are provided at the side surface of the second supporting mechanism, to drive the second supporting mechanism and the components supported by it to rotate around the first rotation axis.

In some examples, an anti-shake holding assembly is further comprised, wherein the anti-shake holding assembly comprises a first holding element and a second holding element, which are respectively provided at the upper and lower side surfaces of the first supporting mechanism.

In some examples, the first supporting mechanism is movably supported on the base bottom surface by the first holding element, and the second supporting mechanism is movably supported on the first supporting mechanism by the second holding element; and the attraction between the first magnetic attraction member and the first driving magnet clamps the first holding element, and the first holding element is held between the base bottom surface and the first supporting mechanism; and the attraction between the second magnetic attraction member and the first driving magnet clamps the second holding element, and the second holding element is held between the first supporting mechanism and the second supporting mechanism.

In some examples, at least one of the first supporting mechanism and the base bottom surface is provided with a groove to accommodate the first holding element, and the first supporting mechanism and other components supported by it rotate around the second rotation axis under the guidance of the first holding element and the groove.

In some examples, at least one first groove is provided at the base bottom surface, and at least one second groove is provided at the lower side surface of the first supporting mechanism; and at least one of the first groove and the second groove is configured to have a groove shape that is compatible with the first holding element in a cross section perpendicular to the second rotation axis, so that the first holding element rolls in situ around the second rotation axis in the first groove or the second groove.

In some examples, at least one of the first supporting mechanism and the second supporting mechanism is provided with a groove to accommodate the second holding element, and the second supporting mechanism and other components supported by it perform planar rotational motion around the first rotation axis under the guidance of the second holding element and the groove.

In some examples, the upper side surface of the first supporting mechanism is provided with at least one third groove, and the lower side surface of the second supporting mechanism is provided with at least one fourth groove; and at least one of the third groove and the fourth groove is configured to have a groove shape extending around the first rotation axis or a groove shape extending along an optical axis and being in a cross section perpendicular to the optical axis, wherein the optical axis is perpendicular to the first rotation axis and the second rotation axis.

According to another aspect of the present application, provided is an optical system, which comprises:
a base comprising a base side wall and a base bottom surface;
a light steering assembly comprising a reflective member for changing an optical path, wherein a light emergent surface of the reflective member defines an optical axis;
a lens assembly provided at a light emergent side of the light steering assembly, and the lens assembly comprises at least one lens portion, a lens carrier and a second driving portion; wherein the lens portion is provided in the lens carrier, and the second driving portion drives the lens carrier to drive the lens portion to move along the optical axis direction;
wherein the second driving portion comprises at least one third driving magnet, and the third driving magnet is provided at both sides of the lens carrier; and
wherein the lens assembly further comprises at least one magnetic conductive sheet and at least one magnetic attraction assembly, the magnetic conductive sheet is provided at the lens carrier, the magnetic attraction assembly is provided at the base bottom surface, a part of the magnetic conductive sheet is opposite to the third driving magnet and is located in the magnetic field of the third driving magnet, and a part of it is provided opposite to the magnetic attraction assembly.

In some examples, the second driving portion further comprises at least one third driving coil, and the third driving magnet is provided at both side surfaces of the lens carrier, and the third driving coil is provided opposite to the third driving magnet.

In some examples, the lens assembly further comprises at least one third holding element, wherein the lens carrier is movably mounted in the base by the third holding element to support part or all of the lens portion.

In some examples, the third holding element is provided between the lens carrier and the base bottom surface.

In some examples, at least one of the lens carrier and the base bottom surface is provided with a groove to accommodate the third holding element.

In some examples, the magnetic conductive sheet is located in the magnetic field of the third driving magnet to be magnetized by the magnetic field, and the lens carrier and the base bottom surface clamp the third holding element through the attraction between the magnetic conductive sheet and the magnetic attraction assembly.

In some examples, the magnetic conductive sheet comprises: a main body, a first side wall and a second side wall, and the first side wall and the second side wall are respectively provided at both sides of the main body and can be formed by an integrally molded metal material.

In some examples, the first side wall and the second side wall are provided at a side of the third driving magnet mounted on the lens carrier facing away from the third driving coil, and the magnetic conductive sheet is magnetized by the magnetic field of the third driving magnet.

In some examples, the main body of the magnetic conductive sheet is provided opposite to the magnetic attraction assembly disposed on the base bottom surface, and the resulting attraction presses the lens carrier toward the base bottom surface.

In some examples, in the horizontal direction, the magnetic attraction assembly is offset from the third driving magnet, and is offset from the third holding element.

According to another aspect of the present application, provided is a light steering assembly for optical image stabilization, which comprises:
a base having a base bottom surface;
a reflective member for changing the optical path, wherein a light emergent surface of the reflective member defines an optical axis;
a first supporting mechanism supported on the base bottom surface;
a second supporting mechanism supporting the reflecting member and provided on the first supporting mechanism; and
a first driving portion comprising a first driving assembly and a second driving assembly, wherein the first driving assembly is located between the first supporting mechanism and the base bottom surface, and the second driving assembly is located between the second supporting mechanism and the base,
wherein the second driving assembly drives the second supporting mechanism and the components supported by it to rotate around the first rotation axis, and the first driving assembly is used to drive the first supporting mechanism and the components supported by it to rotate around the second rotation axis, and the first rotation axis and the second rotation axis are perpendicular to the optical axis and are perpendicular to each other on the same plane.

In some examples, the base integrally extends upward from the base bottom surface to form a base side wall, and a part of the first driving assembly is provided at the base bottom surface, and a part of the second driving assembly is provided at the base side wall.

In some examples, an anti-shake holding assembly is further comprised, wherein the anti-shake holding assembly comprises a first holding element and a second holding element, and the first supporting mechanism is movably supported on the base bottom surface by the first holding element, and the second supporting mechanism is movably supported on the first supporting mechanism by the second holding element.

In some examples, at least one of the first supporting mechanism and the base bottom surface is provided with a groove to accommodate the first holding element.

In some examples, at least one first groove is provided at the base bottom surface, and at least one second groove is provided at the lower side surface of the first supporting mechanism, and the positions and numbers of the first groove and the second groove are consistent with the positions and numbers of the first holding element, and the first groove and the second groove are opposite to each other to fix the first holding element.

In some examples, there are at least two first holding elements provided along the second rotation axis, and the first supporting mechanism and other components supported by it rotate around the second rotation axis under the guidance of the first holding element, the first groove and the second groove.

In some examples, a line connecting the sphere centers of the first holding elements constitutes the second rotation axis, and the first holding elements roll in situ around the second rotation axis in the space formed by the first groove and the second groove, to drive the first supporting mechanism and other components supported by it to rotate around the second rotation axis.

In some examples, at least one of the first supporting mechanism and the second supporting mechanism is provided with a groove to accommodate the second holding element.

In some examples, the upper side surface of the first supporting mechanism is provided with at least one third groove, and the lower side surface of the second supporting mechanism is provided with at least one fourth groove, and the third groove and the fourth groove are opposite to each other to fix the second holding element, and the second supporting mechanism and other components supported by it perform planar rotational motion around the first rotation axis under the guidance of the second holding element and the third groove and the fourth groove.

In some examples, the sphere center of the first holding element and the sphere center of a part of the second holding element are located on the same cross section, and the first holding element and the second holding element are offset from each other in height direction.

Further objects and advantages of the present application will be fully embodied through understanding of the following description and drawings.

These and other objects, features and advantages of the present application are fully embodied in the following detailed description, drawings, and the appended claims.

### BRIEF DESCRIPTION OF THE DRAWINGS

FIG. 1 is an overall schematic diagram of a camera module according to an embodiment of the present application.

FIG. 2 is a schematic diagram of the camera module according to the embodiment of the present application after removing a cover plate.

FIG. 3 is a schematic diagram of the camera module according to the embodiment of the present application that does not comprise a photosensitive assembly.

FIG. 4 is a schematic diagram of an exploded view of the camera module according to the embodiment of the present application.

FIG. 5A is a cross-sectional view of the camera module according to the embodiment of the present application taken along A-A in FIG. 3.

FIG. 5B is a cross-sectional view of the camera module according to the embodiment of the present application taken along B-B in FIG. 3.

FIG. 5C is a cross-sectional view of the camera module according to the embodiment of the present application taken along C-C in FIG. 3.

FIG. 5D is a cross-sectional view of the camera module according to the embodiment of the present application taken along D-D in FIG. 3.

FIG. 6 is a schematic diagram of a base of the camera module according to the embodiment of the present application.

FIG. 7 is a partial schematic diagram of a light steering assembly and a base of the camera module according to the embodiment of the present application.

FIG. 8 is a schematic diagram of a part of structures of a light steering assembly of the camera module according to the embodiment of the present application.

FIG. 9 is a schematic diagram of the structures of the lens assembly of the camera module according to the embodiment of the present application.

FIG. 10 is a schematic diagram of a base, a light steering assembly, and a lens assembly of the camera module according to the embodiment of the present application.

FIG. 11 is a schematic diagram of a main circuit board, a coil, and a base of the camera module according to the embodiment of the present application.

### DETAILED DESCRIPTION

Before any embodiments of the application are explained in detail, it is to be understood that the application is not limited in its application to the details of construction and the arrangement of components set forth in the following description or illustrated in the following drawings. The application is capable of other embodiments, and of being practiced or of being carried out in various ways. Also, it is to be understood that the phraseology and terminology used herein is for the purpose of description, and should not be regarded as limiting. The use of “include/comprise,” “including/comprising,” or “having” and variations thereof herein, are meant to encompass the items listed thereafter and equivalents thereof as well as additional items. Unless specified or limited otherwise, the terms “mount,” “connect,” “support,” and “couple” and variations thereof are used broadly, and encompass direct and indirect mountings, connections, supports, and couplings. Further, “connection” and “coupling” are not restricted to physical or mechanical connections or couplings.

Furthermore, in a first aspect, in the disclosure of the present application, the orientation or positional relationship indicated by terms such as “longitudinal”, “transverse”, “upper”, “lower”, “front”, “back”, “left”, “right”, “vertical”, “horizontal”, “top”, “bottom”, “inside” and “outside” are based on the orientation or positional relationship shown in the accompanying drawings, which are only for the convenience of describing the present application and simplifying the description, rather than indicating or implying that the device or element referred to must have a specific orientation, be constructed and operate in a specific orientation, and therefore the above terms cannot be understood as limitations on the present application; in a second aspect, the term “a/an” should be understood as “at least one” or “one or more”, that is, in one embodiment, the number of an element may be one, while in another embodiment, the number of the element may be multiple, and the term “a/an” cannot be understood as a limitation on the quantity.

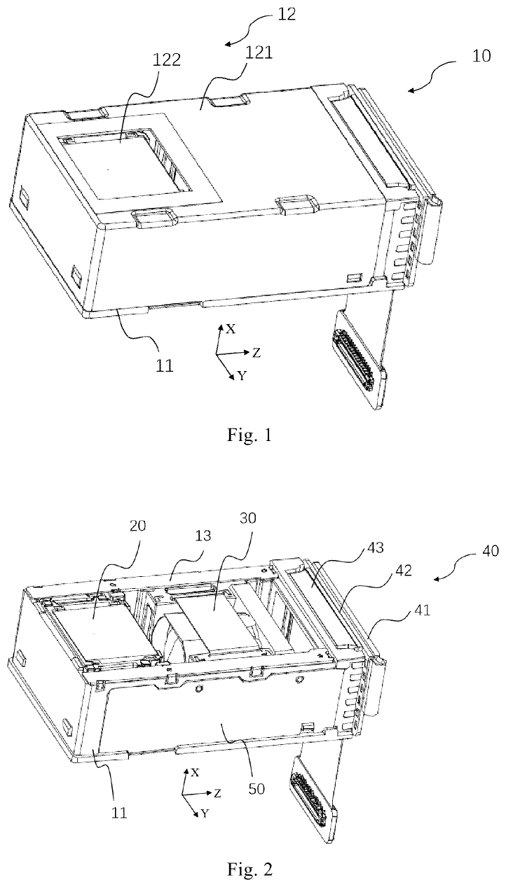

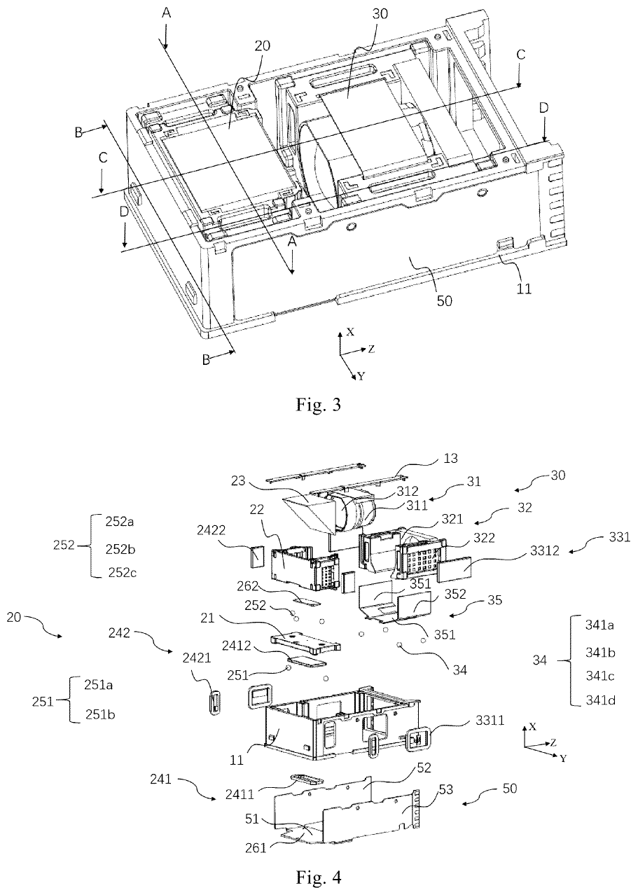

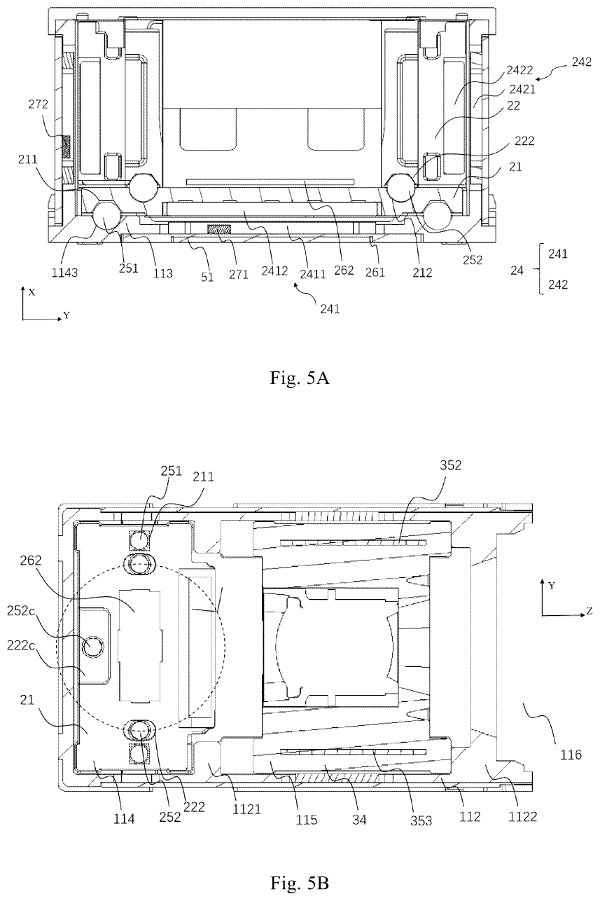

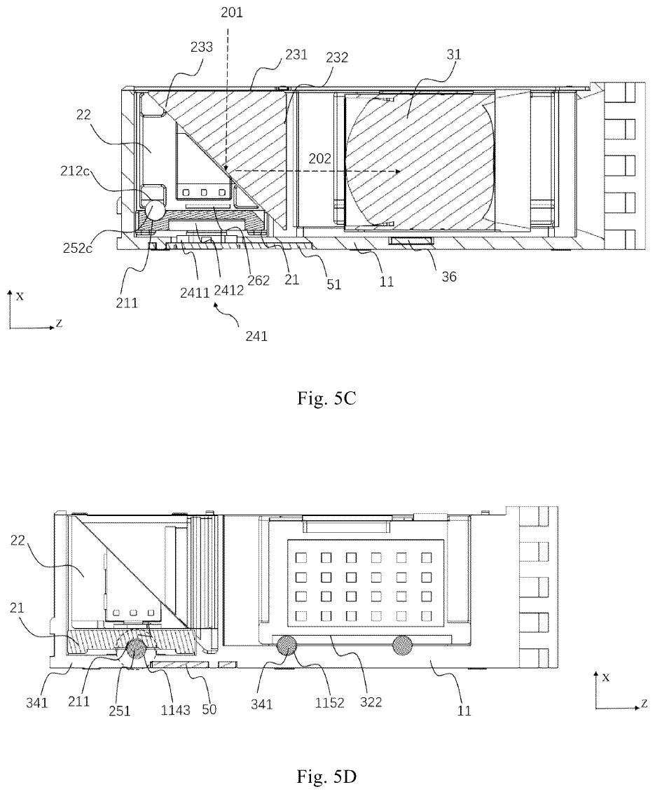

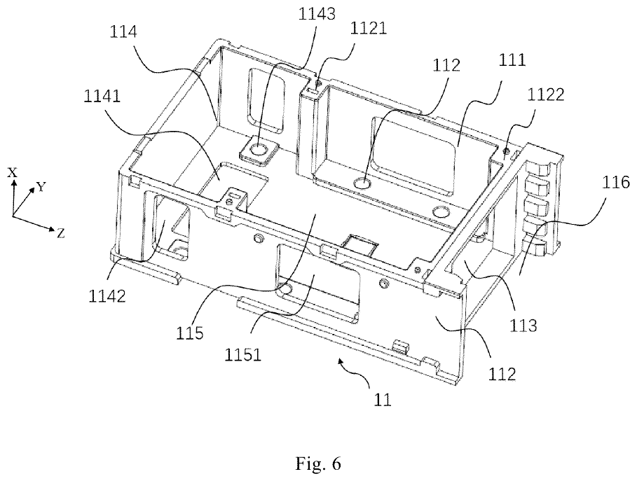

FIG. 1 is an overall schematic diagram of a camera module 1, FIG. 2 is a schematic diagram of the camera module 1 after removing a cover plate, FIG. 3 is a schematic diagram of the camera module 1 excluding a photosensitive assembly, FIG. 4 is a partially decomposed schematic diagram of the camera module 1, FIGS. 5A-5D are cross-sectional views of the camera module 1 (taken along lines A-A, B-B, C-C and D-D in FIG. 3, respectively), and FIG. 6 is a schematic diagram of a camera module base. Referring to FIGS. 1-6, the camera module 1 comprises: a housing 10, a light steering assembly 20 provided in the housing 10, a lens assembly 30, and a photosensitive assembly 40.

The light steering assembly 20 is provided in front of the lens assembly 30, or on a light incident side of the lens assembly 30. The light steering assembly 20 is used to change the path of the incident light. In some alternative examples, a prism or a reflective mirror is used for reflection to achieve light path turning. The lens assembly 30 is provided on the photosensitive path of the photosensitive assembly 40, and the propagation direction of the incident light entering the light steering assembly 20 is changed through the light steering assembly 20, so that the deflected light passes through the optical path of the lens assembly 30. After the light path is corrected by the lens assembly 30, it is received by the photosensitive assembly 40 to form an image.

The housing 10 has a hollow cavity for accommodating the light steering assembly 20, the lens assembly 30 and the photosensitive assembly 40. The housing 10 further comprises a base 11 and a cover plate 12. In the housing 10, the light steering assembly 20 is provided at the light incident side of the lens assembly 30, and the photosensitive assembly 40 is provided at the light emergent side of the lens assembly 30. In other words, along the optical axis direction of the lens assembly, that is, the length direction of light emergent, the light steering assembly 20, the lens assembly 30 and the photosensitive assembly 40 are sequentially provided from one side of the housing 10 to the other side of the housing 10. In some alternative examples, the housing 10 is an integrally formed structure, which comprises an integrally formed base 11 extending along the length direction to provide a better installation reference for the light steering assembly 20, the lens assembly 30 and the photosensitive assembly 40.

Referring to FIGS. 1-6, the base 11 comprises: an base opening 111 at an upper side, a base side wall 112 surrounding the opening, and a base bottom surface 113. The cover plate 12 is provided at the base opening 111 of the base 11. The base sidewall 112, the base bottom surface 113 of the base 11, and the cover plate 12 together constitute the inner space of the housing 10. The cover plate 12 covers the base opening 111, so that the inner space of the housing 10 is not visible. The internal space of the housing 10 comprises: a light steering assembly installation area 114, a lens assembly installation area 115, and a photosensitive assembly installation area 116. Particularly, the light steering assembly installation area 114 is used to accommodate the light steering assembly 20, and the lens assembly installation area 115 is used to accommodate the lens assembly 30, and the photosensitive assembly installation area 116 is used to accommodate the photosensitive assembly 40.

The base 11 can be integrally formed, that is, the base bottom surface 113 is integrally formed, and the base side wall 112 integrally extends upward from the base bottom surface 113 so that the light steering assembly 20, the lens assembly 30 and the photosensitive assembly 40 are provided in the internal space of the housing 10. In some alternative examples, the base 11 may also be formed by connecting separate base parts that are respectively provided with one or more of the light steering assembly 20, the lens assembly 30 and the photosensitive assembly 40.

In some alternative examples, the base side wall 112 is provided with a first protruding wall 1121 and a second protruding wall 1122, wherein the first protruding wall 1121 and the second protruding wall 1122 divide the internal space of the housing 10 into the light steering assembly installation area 114, the lens assembly installation area 115, and the photosensitive assembly installation area 116. Particularly, the first protruding wall 1121 separates the light steering assembly installation area 114 from the lens assembly installation area 115, that is, the light steering assembly 20 is provided at one side of the first protruding wall 1121, and the lens assembly 30 is provided at the other side of the first protruding wall 1121. The second protruding wall 1122 separates the lens assembly installation area 115 from the photosensitive assembly installation area 116, that is, the lens assembly 30 is provided at one side of the second protruding wall 1122, and the photosensitive assembly 40 is provided at the other side of the second protruding wall 1122. Particularly, the first protruding wall 1121 and the second protruding wall 1122 may be formed by extending inward from the base side wall 112.

Referring to FIG. 1, the cover plate 12 comprises a cover plate body 121 and an cover plate opening 122 for incident light to enter. The cover plate body 121 covers the base opening 111 of the base 11, and the cover plate opening 122 is provided above the light steering assembly 20. The incident light enters through the cover plate opening 122, and the light path direction is changed by the light steering assembly 20, then the light passes through the lens assembly 30, and reaches the photosensitive assembly 40, thereby forming an image. The cover plate 12 may be integrally formed to cover the base opening 111 of the base 11, or may be formed by separate components that respectively cover the light steering assembly installation area 114, the lens assembly installation area 115, and the photosensitive assembly installation area 116.

Referring to FIG. 2, the housing 10 of the camera module 1 may further comprise a gasket 13, which is an elastic member and provided between the base 11 and the cover plate 12 to fill a structural gap between the base 11 and the cover plate 12, thereby tightly fixing the base 11 and the cover plate 12.

For ease of understanding, in this application, a spatial coordinate system is established for explanation. The direction of the optical axis of the lens is defined as the Z-axis direction, the first preset direction perpendicular to the plane where the optical axis is located is the X-axis direction, and the second preset direction perpendicular to the plane where the optical axis is located is the Y-axis direction. In the example of the present application, the direction of the incident light is defined as the X-axis direction, and the X-axis direction and the Y-axis direction are perpendicular to each other, and the Z-axis direction is perpendicular to the plane where the X-axis direction and the Y-axis direction are located. In other words, the X-axis, Y-axis and Z-axis constitute a three-dimensional rectangular coordinate system.

The camera module 1 may have at least one of a focus or zoom function, a zoom function, and an optical image stabilization function. In order to realize functions such as focus or zoom, zoom function, and optical image stabilization function, the camera module 1 needs to be equipped with corresponding actuators, which leads to an increase in the size of the camera module, and the installation space reserved for the camera module is also limited.

To this end, the camera module 1 is provided, in which different functions are implemented through different functional assemblies. The camera module 1 comprises a first driving portion 24 and a second driving portion 33, wherein the first driving portion 24 is provided in the light steering assembly 20, and is used to drive the reflecting member 23 for anti-shake; and the second driving portion 33 is provided in the lens assembly 30, and is used to drive the lens portion 31 for focusing or zooming. The light steering assembly 20 realizes an optical image stabilization function, and the lens assembly 30 realizes a focus or zoom function, so that they can be installed in a predetermined internal space of the housing 10, and meet the requirements of miniaturization while realizing image stabilization and focus or zoom.

The light steering assembly 20 changes the path of the light incident through the base opening 111 via the first driving portion 24, so as to achieve an optical image stabilization function. At the time of capturing an image or a moving image, the image may be blurred or the moving image may be jittery due to hand shaking of the user or other shaking. The relative displacement corresponding to the shaking is provided to the first driving portion 24, and the first driving portion 24 drives the reflecting member 23 to correct the hand shaking of the user or other shaking.

The anti-shake function is realized by the movement of the first driving portion 24 which has a relatively low weight since it does not comprise a lens or the like, and therefore, power consumption can be significantly reduced. That is, in order to achieve the anti-shake function, the light on which the anti-shake is performed is directed to be incident on the lens assembly 30 by changing the direction of movement of the light through the movement of the first driving portion 24 on which the reflective member 23 is provided, without moving the lens assembly 30 or the photosensitive assembly 40.

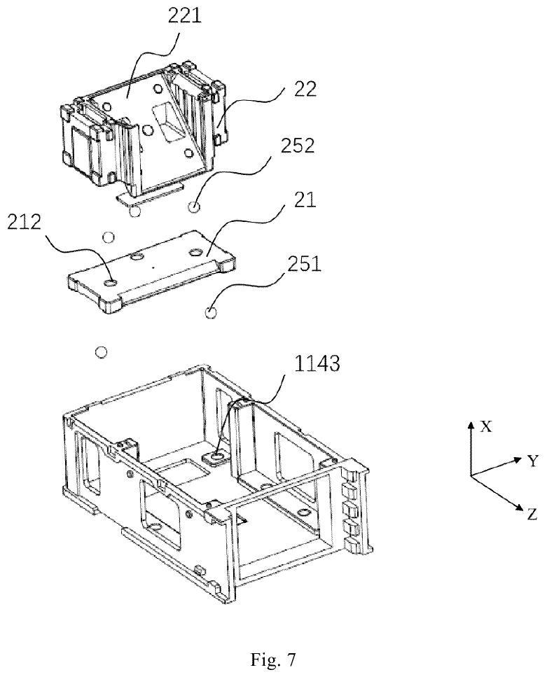

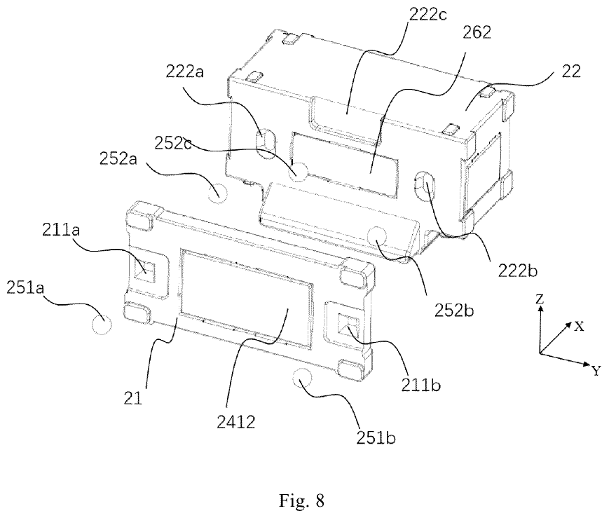

The light is received by the photosensitive assembly 40 through the lens assembly 30 to form an image, and the lens assembly 30 realizes a focusing function. At the time of capturing an image, the lens assembly 30 adjusts the distance between the lens portion 31 and the photosensitive assembly 40 by moving the second driving portion 33 provided with the lens portion 31 to achieve clear imaging. In some alternative examples, the lens assembly 30 only realizes the focus or zoom function, and does not perform the anti-shake function and the zoom function, thereby reducing the structural components and reducing the height size of the lens assembly 30. Of course, the lens assembly 30 may also perform anti-shake and zoom functions in addition to the focus or zoom functions to meet the requirements of different shooting scenes. Referring to FIGS. 2-8, the light steering assembly 20 according to the embodiment of the present application is illustrated. In the present application, the light steering assembly 20 is provided in the light steering assembly installation area 114 of the base 11. The light steering assembly 20 comprises: a first supporting mechanism 21 provided on the base 11 and supported by the base bottom surface 113 of the base, a second supporting mechanism 22 installed on the first supporting mechanism 21, a reflective member 23 installed on the second supporting mechanism 22, and a first driving portion 24 that provides driving force for the reflective member 23.

The reflective member 23 is used to change the optical path. In some alternative examples of the present application, the reflective member 23 is a mirror or a prism that can reflect light. As shown in FIG. 5C, the reflective member 23 enables the light to achieve a 90° turn. The reflective member 23 may be a prism comprising two right-angled surfaces 231 and 232 and a reflective surface 233; wherein the reflective surface 233 is an inclined surface, and each right-angled surface 231 and 232 respectively forms a 45° angle with the reflective surface 233, and a first optical path 201 and a second optical path 202 perpendicular to each other are formed on the reflective surface 233, wherein the first optical path 201 is parallel to the incident light direction, and the second optical path 202 is parallel to the lens assembly. The lens assembly 30 and the photosensitive assembly 40 are provided on the second optical path 202 in sequence, that is, the first optical path 201 is parallel to the X-axis direction, and the second optical path 202 is parallel to the Z-axis direction. The right-angle surface 231 is the incident surface, and the right-angle surface 232 is the emergent surface. The incident light enters along the first optical path 201 from the right-angle surface 231, and is reflected by the reflective surface 233 to change the light path, and is emitted from the reflective member 23 through the right-angle surface 232 along the second optical path 202, then passes through the lens assembly 30, and reaches the photosensitive assembly 40.

The reflective member 23 is fixedly provided at the second supporting mechanism 22. The second supporting mechanism 22 comprises a installation surface 221, which may be an inclined surface adapted to the reflective surface 233 of the reflective member 23, so that the reflective member 23 is stably fixed on the second supporting mechanism 22.

Particularly, the second supporting mechanism 22 is movably installed in the inner space of the housing 10. In an example of the present application, the second supporting mechanism 22 can rotate around the first rotation axis and the second rotation axis, and the first rotation axis is parallel to the X axis, and the second rotation axis is parallel to the Y axis.

The second supporting mechanism 22 is movably provided on the first supporting mechanism 21, and is rotatable relative to the first supporting mechanism 21 around the first rotation axis.

The first supporting mechanism 21 is movably provided on the base 11, and is rotatable relative to the base 11 around the second rotation axis. The first driving portion 24 is suitable for driving the reflective member 23 to move, that is, driving the reflective member 23 to perform optical image stabilization. The first driving portion 24 comprises a first driving assembly 241 and a second driving assembly 242, and the first driving assembly 241 is located between the first supporting mechanism 21 and the base bottom surface 113, and the second driving assembly 242 is located between the second supporting mechanism 22 and the base 11, and the first driving assembly 241 is used to drive the reflective member 23 to move around the second rotation axis, and the second driving assembly 242 is used to drive the reflective member 23 to move around the first rotation axis.

Particularly, the first driving assembly 241 comprises a first driving coil 2411 and a first driving magnet 2412. In some alternative examples, the first driving magnet 2412 is provided at the first supporting mechanism 21, and the first driving coil 2411 is provided opposite to the first driving magnet 2412. In one example of the present application, the first driving magnet 2412 is provided at the lower side surface of the first supporting mechanism 21, and a receiving groove is provided at the lower surface of the first supporting mechanism 21 for accommodating the first driving magnet 2412. A first driving coil slot 1141 is provided at the base bottom surface 113 corresponding to the light steering assembly installation area 114. The first driving coil 2411 is provided in the first driving coil slot 1141 of the base 11, so that the first driving coil 2411 is located in the magnetic field of the first driving magnet 2412.

Particularly, the second driving assembly 242 comprises a second driving coil 2421 and a second driving magnet 2422. In some alternative examples, the second driving magnet 2422 is provided at the second supporting mechanism 22, and the second driving coil 2421 is provided opposite to the second driving magnet 2422. In one example of the present application, the number of the second driving magnets 2422 can be two, namely 2422a and 2422b, which are respectively provided at both sides of the second supporting mechanism 22. The second supporting mechanism 22 is provided with receiving grooves on both sides opposite to the two long side walls of the base 11 for accommodating the second driving magnets 2422. The number of the second driving coils 2421 is the same as that of the second driving magnets 2422, namely 2421a and 2421b. The second driving coil slot 1142 is provided at the base side wall 112 corresponding to the light steering assembly installation area 114, and the second driving coil 2421 is provided in the second driving coil slot 1142 of the base 11, so that the second driving coil 2421 is located in the magnetic field of the second driving magnet 2422.

The light steering assembly 20 further comprises an anti-shake holding assembly 25 comprising a first holding element 251 and a second holding element 252. The first supporting mechanism 21 is supported on the base 11 by the first holding element 251. The first holding element 251 has a spherical or cylindrical structure, so that the first supporting mechanism 21 rotates around the second rotation axis under the action of a driving coil or other types of driving assembly. The second supporting mechanism 22 is supported on the base 11 by the first holding element 251 and the second holding element 252. The second holding element 252 has a spherical or cylindrical structure, so that the second supporting mechanism 22 can rotate around any one of the second rotation axis and the first rotation axis under the action of a driving coil or other type of driving assembly.

In some alternative examples, the first holding element 251 and the second holding element 252 are respectively provided at the upper side surface and the lower side surface of the first supporting mechanism 21, that is, the first holding element 251 is provided between the base 11 and the first supporting mechanism 21, and the second holding element 252 is provided between the first supporting mechanism 21 and the second supporting mechanism 22. The first supporting mechanism 21 and other components supported by it (including but not limited to: the second holding element 252, the second supporting mechanism 22, the reflective member 23 and other components) rotate around the second rotation axis under the guidance of the first holding element 251 and at least one second groove 211 provided at the first supporting mechanism 21 and/or at least one first groove 1143 provided at the base 11. In other words, the above structures drive the reflective member 23 to rotate around the second rotation axis. In some alternative examples, the second supporting mechanism 22 and other components supported by it (including but not limited to: the reflective member 23 and other components) rotate around the first rotation axis under the guidance of the second holding element 252 and at least one third groove 212 provided at the first supporting mechanism 21 and/or at least one fourth groove 222 provided at the second supporting mechanism. In other words, the above structures drive the reflective member 23 to rotate around the first rotation axis.

It is worth mentioning that in the present patent application, the base 11 preferably adopts an integrated molding solution. The above solution enables the first supporting mechanism 21, the first holding element 251 and the first driving assembly 241 of the light steering assembly 20 to be at least partially provided at the bottom surface of the base 11. Furthermore, the second holding element 252 is also provided near the bottom side of the base 11, which can facilitate assembly in the case of an integrated molding base, and at the same time can effectively accommodate the above-mentioned driving assembly and supporting/holding element to achieve miniaturization.

The first supporting mechanism 21 can be movably supported on the base bottom surface 113, and the first holding element 251 is provided between the first supporting mechanism 21 and the base bottom surface 113. At least one of the first supporting mechanism 21 and the base bottom surface 113 is provided with a groove to accommodate the first holding element 251.

Referring to FIGS. 5A-5C and FIG. 6, in some alternative examples, at least one first groove 1143 is provided at the base bottom surface 113 corresponding to the light steering assembly installation area 114, and at least one second groove 211 is provided at the lower side surface of the first supporting mechanism 21, and the first groove 1143 and the second groove 211 are opposite to each other to fix the first holding element 251.

The first holding element 251 is partially inserted into the first groove 1143 of the base 11 and the second groove 211 of the first supporting mechanism 21, wherein the positions and numbers of the first groove 1143 and the second groove 211 may correspond to the position and number of the first holding element 251.

The number of the first holding element s 251 is at least two. In some alternative examples of the present application, the first holding element 251 may comprise holding elements 251a and 251b, which are provided along the Y axis (i.e., the second rotation axis) and symmetrically disposed. The first groove 1143 of the base 11 comprises first grooves 1143a and 1143b, which are provided along the Y axis and symmetrically disposed. The second groove 211 of the first supporting mechanism 21 comprises second grooves 211a and 211b, which are provided along the Y axis and symmetrically provided. The first groove 1143 and the second groove 211 are opposite to each other to fix the first holding element 251. The first supporting mechanism 21 and other components supported by it rotate around the second rotation axis under the guidance of the first holding element 251 and the first groove 1143 and/or the second groove 211. Therefore, at least one of the first groove 1143 and the second groove 211 is configured to have a groove shape that is compatible with the first holding element 251 in a cross section perpendicular to the second rotation axis.

In some alternative examples, the first holding element 251 may be a spherical member. The first holding element 251 may be partially inserted into the first groove 1143 provided at the base 11 or may be partially inserted into the second groove 211 of the first supporting mechanism 21. In order to enable the first holding element 251 to rotate around the second rotation axis, the movement in other directions is limited; at least one of the first groove 1143 and the second groove 211 is configured to be a groove compatible with the first holding element 251, and can be configured based on the shape of the first holding element 251. In one example of the present application, as shown in FIGS. 5A-6, the first holding element 251 is a spherical member; the first groove 1143 is configured as a hemispherical groove based on the spherical member, the second groove 211 is a slot shape, and the first holding element 251 can roll in the hemispherical first groove 1143.

In one example of the present application, the first holding element 251 is a spherical member, and a hemispherical groove compatible with the first holding element 251 is provided at the base bottom surface 113 to fix the lower half part of the first holding element 251. The lower side surface of the first supporting mechanism 21 is provided with a slot-shaped groove to fix the upper half part of the first holding element 251. The first supporting mechanism 21 and other components supported by it rotate around the second rotation axis under the guidance of the spherical first holding element 251, the hemispherical groove on the base bottom surface 113 and the slot-shaped groove of the first supporting mechanism 21. Particularly, the first holding element 251 may comprise holding elements 251a and 251b, and a line connecting the sphere centers of the holding elements 251a and 251b constitutes the second rotation axis. The first holding element 251 rolls in situ around the second rotation axis in the hemispherical first groove 1143, guiding the first supporting mechanism 21 and other components supported by it to rotate relative to the base 11 around the second rotation axis.

It is worth mentioning that in the present application, the first holding element 251 rolls in situ around the second rotation axis in the space formed by the first groove 1143 and the second groove 211, to drive the first supporting mechanism 21 and the components supported by it to rotate around the second rotation axis, thereby achieving large-angle rotation adjustment through small displacement, while being able to provide sufficient driving force in a limited space, to improve driving efficiency.

The second supporting mechanism 22 is movably supported on the first supporting mechanism 21, and the second holding element 252 is provided between the first supporting mechanism 21 and the second supporting mechanism 22. At least one of the first supporting mechanism 21 and the second supporting mechanism 22 is provided with a groove to accommodate the second holding element 252. In some alternative examples, at least one third groove 212 is provided at the upper side surface of the first supporting mechanism 21, and at least one fourth groove 222 is provided at the lower side surface of the second supporting mechanism 22. The third groove 212 and the fourth groove 222 are opposite to each other to fix the second holding element 252.

The second holding element 252 is partially inserted into the third groove 212 of the first supporting mechanism 21 and the fourth groove 222 of the second supporting mechanism 22, and the positions and numbers of the third groove 212 and the fourth groove 222 may correspond to the position and number of the second holding element 252.

The number of the second holding element 252 is at least two. In some alternative examples of the present application, the second holding element 252 may comprise second holding elements 252a, 252b and 252c. Particularly, the second holding elements 252a and 252b are provided along the Y axis and symmetrically disposed; and the second holding element 252c is provided at the mid-perpendicular line of the second holding elements 252a and 252b, and is offset from the second holding elements 252a and 252b. Particularly, the second supporting mechanism 22 and other components supported by it perform planar rotational motion around the first rotation axis under the guidance of the second holding elements 252a and 252b and the third groove 212 and the fourth groove 222. The second holding element 252c provides a stable support point, so that the second supporting mechanism 22 and other components supported by it remain stable during planar rotation. Correspondingly, the upper side surface of the first supporting mechanism 21 is provided with the third groove 212 comprising third grooves 212a, 212b and 212c, and the lower side surface of the second supporting mechanism 22 is provided with the fourth groove 222 comprising fourth grooves 222a, 222b and 222c. The third groove 212 and the fourth groove 222 are opposite to each other to fix the second holding element 252, that is, the second holding element 252a is provided between the third groove 212a and the fourth groove 222a, the second holding element 252b is provided between the third groove 212b and the fourth groove 222b, and the second holding element 252c is provided between the third groove 212c and the fourth groove 222c. The second supporting mechanism 22 and other components supported by it can perform planar rotational motion around the first rotation axis under the guidance of the second holding elements 252a, 252b and the third groove 212 and the fourth groove 222. Therefore, at least one of the third groove 212 and the fourth groove 222 is provided with a groove shape extending around the first rotation axis or a groove shape extending along the optical axis (Z axis) and being in a cross section perpendicular to the optical axis (Z axis).

In one example of the present application, a part of the fourth groove 222 of the second supporting mechanism 22 is a trapezoidal groove, and a part of it is a planar groove, so as to realize the rotational movement of the second supporting mechanism 22 and other components around the first rotation axis. Particularly, the fourth grooves 222a, 222b are trapezoidal grooves, the fourth groove 222c is a planar groove, and the fourth grooves 222a, 222b and 222c are provided based on the first rotation axis, so that the second holding element 252 drives the second supporting mechanism 22 and other components to rotate around the first rotation axis.

In some alternative examples, the second holding element 252 may be a spherical member. The second holding element 252 may be partially inserted into the third groove 212 of the first supporting mechanism 21 and the fourth groove 222 of the second supporting mechanism 22. In order to enable the second holding element 252 to drive the second supporting mechanism 22 to rotate around the first rotation axis while limiting the movement in other directions, at least one of the third groove 212 and the fourth groove 222 is configured to be a groove compatible with the second holding element 252, and can be configured based on the shape of the second holding element 252. In one example, as shown in FIGS. 5A-6, the second holding element 252 is a spherical member, the third groove 212 is configured as a hemispherical groove based on the spherical member, a part of the fourth groove 222 is a trapezoidal groove, and a part of it is a planar groove; and a part of the second holding element 252 can roll in the hemispherical third groove 212.

In one example of the present application, the second holding element 252 is a spherical member, and the upper side surface of the first supporting mechanism 21 is provided with a hemispherical groove compatible with the second holding element 252 to fix the lower half part of the second holding element 252, and the lower side surface of the second supporting mechanism 22 is provided with a trapezoidal groove to fix the upper half part of the second holding element 252; ad the second holding element 252 comprises holding elements 252a, 252b and 252c, and the first rotation axis is formed by passing the midpoint of the line connecting the sphere centers of the second holding elements 252a and 252b and parallel to the X-axis. The line connecting the sphere centers of the second holding elements 252a and 252b constitutes a rotation diameter, and the second holding element 252c forms a stable fulcrum, that is, the two spherical members form a planar rotation circle, and the third spherical member forms a planar rotation support point. The second holding element 252 rolls in situ in the hemispherical third groove 212 in a direction parallel to the first rotation axis, to guide the second supporting mechanism 22 and other components supported by it to rotate around the first rotation axis with a rotation radius of half of the line connecting the sphere centers of the second holding elements 252a and 252b, thereby realizing rotational motion within a plane.

In some alternative examples, in order to ensure that the movement of the first supporting mechanism 21 and the components supported by it around the second rotation axis driven by the first holding element 251 and the movement of the second supporting mechanism 22 and the components supported by it around the first rotation axis driven by the second holding element 252 do not interfere with each other, that is, when the second supporting mechanism 22 is driven by the second holding element 252 to rotate around the first rotation axis, the first holding element 251 inserted into the first groove 1143 and the second groove 211 does not move but needs to be fixed. Therefore, at least one of the first groove 1143 and the second groove 211 which are opposite to each other is provided with a shape in which the width along the cross section parallel to the XY plane decreases as the depth increases, wherein the cross section of the groove may be a “V” shape, a “U” shape, a circular shape or a polygonal shape to limit the movement of the first holding element 251 around the first rotation axis. Similarly, when the first supporting mechanism 21 is driven by the first holding element 251 to rotate around the second rotation axis, the second holding element 252 inserted into the third groove 212 and the fourth groove 222 does not move, and the width of at least one of the third groove 212 and the fourth groove 222 which are opposite to each other along the cross-section parallel to the XY plane decreases as the depth increases to limit the movement of the second holding element 251 around the second rotation axis, wherein the cross section of the groove may be a “V” shape, a “U” shape, a circular shape or a polygonal shape. In addition, in order to facilitate the movement or rotation of the first holding element 251 and the second holding element 252, the depth of each groove among the first groove 1143, the second groove 211, the third groove 212, and the fourth groove 222 is less than the radius of the groove, so that the first holding element 251 and the second holding element 252 are not inserted as a whole in the grooves, but are partially exposed, so that the first supporting mechanism 21 and the components supported by it can be easily rotated under the guidance of the first holding element 251 and the first groove 1143 and the second groove 211; and the second supporting mechanism 22 and the components supported by it can be easily rotated under the guidance of the second holding element 252 and the third groove 211 and the fourth groove 222.

In some examples of the present application, referring to FIGS. 5A-5B, the first rotation axis and the second rotation axis are on the same cross section and intersect each other perpendicularly. The sphere centers of the holding elements 251a and 251b of the first holding element 251 and the holding elements 252a and 252b of the second holding element 252 are located on the same XY cross section, to prevent the rotational movement of one layer of holding elements from interfering with the movement of another layer of holding elements.

In some examples of the present application, referring to FIGS. 5A-5B, the first holding element 251 and the second holding element 252 are offset from each other along the X-axis direction (height direction), thereby reducing the thickness of the first supporting mechanism 21, thus reducing the height of the light steering assembly 20, and thereby achieving miniaturization and thinness of the camera module.

It is worth mentioning that in the present application, the first supporting mechanism 21 and other components supported by it (including but not limited to: the second supporting mechanism 22, the reflecting member 23, etc.) rotate around the second rotation axis under the guidance of the first holding element 251, the first groove 1143 on the base bottom surface 113, and the second groove 211 of the first supporting mechanism 21; and the second supporting mechanism 22 and the components supported by it (including but not limited to: the reflecting member 23, etc.) rotate around the first rotation axis under the guidance of the second holding element 252, the third groove 211 and the fourth groove 222. Therefore, the friction force that needs to be overcome for moving around the second rotation axis is greater than the friction force that needs to be overcome for moving around the first rotation axis. For this reason, the driving force required for moving around the second rotation axis is greater than the driving force required for moving around the first rotation axis. The first holding element 251 rolls in situ around the second rotation axis in the space formed by the first groove 1143 and the second groove 211, which can greatly reduce the driving energy consumption of the driving assembly.

When the first driving coil 2411 is energized, the first supporting mechanism 21 on which the first driving magnet 2412 is mounted rotates around the second rotation axis through the electromagnetic force between the first driving coil 2411 and the first driving magnet 2412, thereby driving other components supported by the first supporting mechanism 21 (including but not limited to the second supporting mechanism 22 and the reflective member 23 located on the second supporting mechanism 22) to rotate around the second rotation axis. When the second driving coil 2421 is energized, the second supporting mechanism 22 on which the second driving magnet 2422 is mounted rotates around the first rotation axis through the electromagnetic force between the second driving coil 2421 and the second driving magnet 2422, thereby driving the reflective member 23 and other components supported by the second supporting mechanism 22 to rotate around the first rotation axis.

The light steering assembly 20 further comprises a magnetic attraction assembly 26. The magnetic attraction assembly 26 comprises at least one first magnetic attraction member 261 and at least one second magnetic attraction member 262. The first magnetic attraction member 261 and the second magnetic attraction member 262 are respectively provided at the upper and lower side surfaces (along the X-axis) of the first driving magnet 2412, each of them and the first driving magnet 2412 are attracted to each other. In some alternative examples, the first magnetic attraction member 261 is provided at the base bottom surface 113 or on a circuit board 50 connected to the base bottom surface 113, and is located on the lower side of the first driving magnet 2412; the first driving coil 2411 is provided between the first magnetic attraction member 261 and the first driving magnet 2412. The second magnetic attraction member 262 is provided at the lower side surface of the second supporting mechanism 22, and is provided opposite to the first driving magnet 2412. In some alternative examples, a placement groove is provided at the lower side surface of the second supporting mechanism 22, and the second magnetic attraction member 261 is provided in the placement groove or the second magnetic attraction member 261 is integrally formed at the lower end of the second supporting mechanism 22.

It is worth mentioning that in the present application, the base 11 preferably adopts an integrated molding solution. The above solution enables the first supporting mechanism 21 and the second supporting mechanism 22 to be tightly provided at the base 11 through the attraction between the first magnetic attraction member 261 or the second magnetic attraction member 262 and the first driving magnet 212. On the other hand, the attraction between the first magnetic attraction member 261 and the first driving magnet 212 clamps the first holding element 251 tightly, so that the first holding element 251 is tightly retained between the base bottom surface 113 and the first supporting mechanism 21. Similarly, the attraction between the second magnetic attraction member 262 and the first driving magnet 212 clamps the second holding element 252 tightly, so that the second holding element 252 is tightly retained between the first supporting mechanism 21 and the first supporting mechanism 22.

Through a single driving magnet, a first magnetic attraction member 261 and a second magnetic attraction member 262 are respectively provided at the upper and lower sides of the driving magnet to clamp the two layers of holding elements respectively. On the one hand, the number of structural parts is reduced, the structure is compact and simple, and the weight of the driving assembly of the optical image stabilization is reduced. While achieving miniaturization, sufficient driving force is provided to the reflective member 23 to achieve image stabilization. On the other hand, the two layers of holding elements are stacked in the height direction, and can be assembled based on an integrally formed base, which makes assembly easy. In some alternative examples, the light steering assembly 20 further comprises at least one sensing assembly 27, through which the positions of the first supporting mechanism 21 and the second supporting mechanism 222 are detected, to provide feedback and realize closed-loop control. The sensing assembly 27 comprises a Y-axis sensing element 271 and an X-axis sensing element 272, which are respectively provided at the inner side or the outer side of the second driving coil 2421 and the first driving coil 2411.

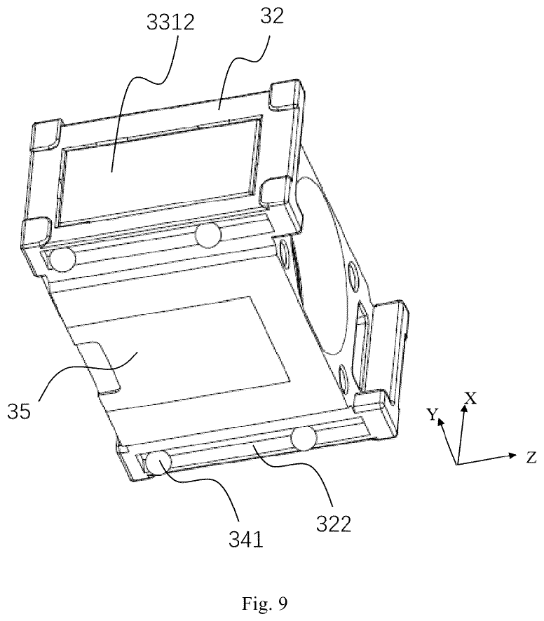

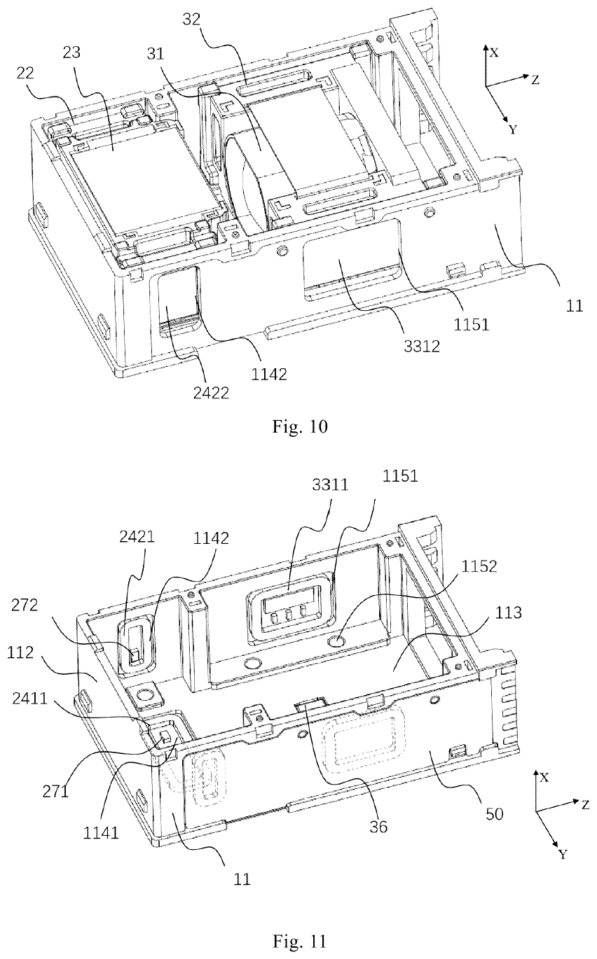

Referring to FIGS. 2-11, the lens assembly 30 is provided in the inner space of the housing 10, and is provided in the lens assembly installation area 115 of the base 11.

The lens assembly 30 is provided at the light emergent side of the light steering assembly 20, and the incident light enters the lens assembly 30 after being reflected by the light steering assembly 20. The lens assembly 30 comprises at least a lens portion 31, a lens carrier 32, and a second driving portion 33. The lens carrier 32 is provided at the base 11, and supported by the base bottom surface 113. The lens portion 31 is provided in the lens carrier 32, and the second driving portion 33 drives the lens carrier 32 to move along the Z axis, thereby driving the lens portion 31 to translate along the Z axis. Particularly, the second driving portion 33 is used to drive the lens carrier 32 and the lens unit 31 to achieve a focus or zoom function, or zoom function. The lens assembly 30 does not comprise a driving assembly for anti-shake, and thus has a relatively low weight. The second driving portion 33 provides sufficient driving force to the lens portion 31, thereby achieving low-power driving.

The lens portion 31 comprises a lens barrel 311 and a lens group 312 installed in the lens barrel 311. The lens group 311 is stacked along the Z-axis direction, to form an optical system with the reflective member 23 of the light steering assembly 20. The lens portion 31 comprises a light incident side and a light emergent side opposite to the light incident side, and the light incident side corresponds to the light steering assembly 20, and the light emergent side corresponds to the photosensitive assembly 40, that is, the light incident side is the object side of the lens portion 31, and the light emergent side is the image side of the lens portion 31. In some alternative examples, in order to reduce the overall height of the camera module and the weight of the lens portion, a D-cut lens portion 31 is used, that is, the radial dimension in the X-axis direction is smaller than the radial dimension in the Y-axis direction.

The lens carrier 32 is movably installed in the inner space of the housing 10, and can move along the Z axis to support part or the whole of the lens portion 31. The lens carrier 32 comprises a mounting cavity 321, which is a U-shaped structure, i.e., has a top opening, and is suitable for mounting the lens portion 31 into the mounting cavity 321 from the top of the lens carrier 32.

The second driving portion 33 is used to drive the lens carrier 32 and the lens portion 31 to move in the optical axis direction (Z axis), to change the distance between the lens portion 31 and the photosensitive assembly 40, thereby realizing the focusing or zooming function. The second driving portion 33 comprises a third driving assembly 331 comprising at least one third driving coil 3311 and at least one third driving magnet 3312. In some alternative examples, the third driving magnet 3312 is provided at both sides of the lens carrier 32, and the third driving coil 3311 is provided at the opposite side of the third driving magnet 3312. In some examples of the present application, mounting grooves are provided at two side surfaces of the lens carrier 32 opposite to the base side wall 112 for accommodating the third driving magnet 3312. A third driving coil slot 1151 is provided at the base side wall 112 corresponding to the lens assembly installation area. The third driving coil 3311 is provided in the third driving coil slot 1151 of the base 11, so that the third driving coil 3311 is located in the magnetic field of the third driving magnet 3312.

When the third driving coil 3311 is energized, the lens carrier 32 on which the third driving magnet 3312 is mounted can move along the optical axis direction (Z axis) through the electromagnetic force between the third driving magnet 3312 and the third driving coil 3311, thereby driving the lens portion 31 to move along the optical axis direction to achieve focusing.

The lens assembly 30 further comprises a lens holding assembly 34 comprising at least one third holding element 341. The lens carrier 32 is movably supported on the base 11 through the third holding element 341, so that the lens carrier 32 moves along the optical axis direction (Z axis) to achieve focusing. Particularly, the third holding element 341 is provided between the lens carrier 32 and the base bottom surface 113. The lens carrier 32 and other components supported by it (including but not limited to the lens portion 31) move along the optical axis direction (Z axis) under the guidance of the third holding element 341, and at least one fifth groove 1152 provided at the base 11, and/or at least one sixth groove 322 of the lens carrier 32. In addition, the third holding element 341 can also be used to maintain the distance between the lens carrier 32 and the base 11.

Referring to FIG. 5D, the lens carrier 32 may be movably supported on the base bottom surface 113, and the third holding element 341 is provided between the lens carrier 32 and the base bottom surface 113. At least one of the lens carrier 32 and the base bottom surface 113 is provided with a groove to accommodate the third holding element 341. In some alternative examples, at least one fifth groove 1152 is provided at the base bottom surface 113 corresponding to the lens assembly installation area 115, and at least one sixth groove 322 is provided at the lower side surface of the lens carrier 32. The fifth groove 1152 and the sixth groove 322 are opposite to each other to fix the third holding element 341.

The third holding element 341 is partially inserted into the fifth groove 1152 of the base 11 and the sixth groove 322 of the lens carrier 32. Particularly, the position and number of the fifth groove 1152 and the sixth groove 322 correspond to the position and number of the third holding element 341.

In some alternative examples of the present application, the third holding element 341 may comprise third holding elements 341a, 341b, 341c and 341d. Particularly, the third holding elements 341a and 341b are provided along the Z axis, and the third holding elements 341c and 341d are provided along the Z axis, the third holding elements 341a and 341c are symmetrically provided along the Y axis, and the third holding elements 341b and 341d are symmetrically provided along the Y axis. The fifth groove 1152 of the base 11 comprises fifth grooves 1152a, 1132b, 1132c and 1132d, which correspond one-to-one to the positions of the third holding elements 341, and the sixth groove 322 of the lens carrier 321 comprises sixth grooves 322a, 321b, 321c and 321d, which correspond to the positions of the third holding elements 341. The fifth groove 1152 and the sixth groove 322 are opposite to each other to fix the third holding element 341.

The third holding element 341 may be partially inserted into the fifth groove 1152 provided at the base 11, or may be partially inserted into the sixth groove 322 of the lens carrier 32. In order to enable the lens carrier 32 and other components supported by it to move along the optical axis direction (Z axis) under the guidance of the third holding element 341, and the fifth groove 1152 provided at the base 11, and/or the sixth groove 322 of the lens carrier 32, while restricting movement in other directions, at least one of the fifth groove 113 and the sixth groove 322 is configured to have a groove shape that is compatible with the third holding element 341 in a cross section perpendicular to the Z axis.

In some examples of the present application, in order to achieve stable support, at least one of the fifth groove 1152 and the sixth groove 322 can be configured as a groove matching with the third holding element 341, and can be configured based on the shape of the third holding element 341. The third holding element 341 can be a spherical member, the fifth groove 1152 is configured as a hemispherical groove based on the third holding element 341, and the sixth groove 322 is configured as a groove shape extending along the Z-axis direction, and the third holding element 341 can roll in the hemispherical fifth groove 1152. In some alternative examples, the sixth grooves 322a, 321b, 321c, and 321d can be independent grooves, or the sixth groove 322a is connected to the sixth groove 321b, and the sixth groove 322c is connected to the sixth groove 321d, forming long grooves extending along the Z-axis direction on both sides of the lower side surface of the lens carrier 32, that is, the third holding elements 341a and 341b share a groove, and the third holding elements 341c and 341d share a groove. The structure of the lens carrier 32 is simplified by the shared groove structure of the single-sided third holding elements, thereby reducing the weight of the lens carrier 32 and the power consumption. Meanwhile, the focusing travel distance of the lens carrier 32 and the lens portion 31 is increased.

In one example of the present application, the third holding element 341 is a spherical member, the base 11 uses a hemispherical groove matching with the third holding element 341 to fix the lower half part of the third holding element 341, and the lens carrier 32 uses a groove-shaped slot to fix the upper half part of the third holding element 341, guiding the lens carrier 32 and the lens portion 31 and other components supported by it to move along the optical axis direction (Z axis) under the driving action of the third driving assembly 331. Particularly, the third holding element 341 rolls in situ in the hemispherical fifth groove 1152 with high precision, the motion mechanism is stable and has little impact on the “tilt” of the lens carrier 32 during the movement along the optical axis, thereby making the imaging more stable. Referring to FIGS. 4-9, the lens assembly 30 further comprises at least one magnetic conductive sheet 35 and at least one focusing or zooming magnetic attraction assembly 36. The magnetic conductive sheet 35 is provided in the lens carrier 32, and the focusing or zooming magnetic attraction assembly 36 is provided at the base bottom surface 113 corresponding to the lens assembly installation area 115. The magnetic conductive sheet 35 and the focusing or zooming magnetic attraction assembly 36 generate a mutual attraction force. The attraction between the magnetic conductive sheet 35 and the focusing or zooming magnetic attraction assembly 36 causes the lens carrier 32 and the base bottom surface 113 to clamp the third holding element 341 tightly, so that the third holding element 341 is tightly retained between the lens carrier 32 and the base bottom surface 113. The lens carrier 32 is pressed toward the base bottom surface 113, so that the third holding element 341 maintains contact with the lens carrier 32 and the base bottom surface 113. Particularly, along the YZ plane direction (horizontal direction), the focusing or zooming magnetic attraction assembly 36 is offset from the third driving magnet 3312, and is offset from the third holding element 341.

In some alternative examples, the magnetic conductive sheet 35 comprises a main body 351, a first side wall 352 and a second side wall 353. The two side walls 352 and 353 are respectively provided at two sides of the main body 351, and may be formed by an integrally molded metal material. The first side wall 352 and the second side wall 353 are provided at a side of the third driving magnet 3312 mounted on the lens carrier 32 which is facing away from the third driving coil 3311, and are magnetized by the magnetic field of the third driving magnet 3312. The main body 351 of the magnetic conductive sheet 35 is provided opposite to the focusing or zooming magnetic attraction assembly 36 provided at the base bottom surface 113, thereby forming a mutual attractive force to tightly clamp the third holding element 341. Particularly, the magnetic conductive sheet 35 can be integrally molded in the lens carrier 32.

It is worth mentioning that in the present application, the focusing or zooming magnetic attraction assembly 36 indirectly generates attraction with the third driving magnet 3312 to clamp the third holding element 341, and by providing an additional magnetic conductive sheet 35, through magnetization, it interacts with the focusing or zooming magnetic attraction assembly 36 located on the base bottom surface 113, so as to make enough space for the third holding element 341 and the sixth groove 322 of the lens carrier 32, and the fifth groove 1153 on the base bottom surface 113, instead of the original focusing or zooming magnetic attraction assembly 36 directly provided at the base bottom surface 113 opposite to the third driving magnet 3312, so that the installation position of the third holding element 341 and the fifth groove 1153 on the base bottom surface 113 is limited by installation position of the focusing or zooming magnetic attraction assembly 36. In addition, the clamping force of the original focusing or zooming magnetic attraction assembly 36 and the third driving magnet 3312 is limited by the height distance of the third holding element 341, and the distance between the magnetic conductive sheet 35 and the focusing or zooming magnetic attraction assembly 36 can be close enough to provide sufficient clamping force for clamping the third holding element 341.

The camera module 1 further comprises a main circuit board 50, the first driving portion 24 comprises the first driving coil 2411 and the second driving coil 2421 for driving the reflective member 23, and the second driving portion 33 comprises the third driving coil 3311 for driving the lens portion 31. The first driving coil 2411, the second driving coil 2421 and the third driving coil 3311 are provided at the main circuit board 50, and the first driving coil slot 1141, the second driving coil slot 1142 and the third driving coil slot 1151 are provided at the base 11, so that when the main circuit board 50 is installed on the base 11, each coil is exposed to the internal space of the base 11.

FIG. 11 shows a schematic diagram of a perspective view of the main circuit board 50 and the coils and components mounted thereon. In some alternative examples, the main circuit board 50 comprises a bottom substrate 51, a first side substrate 52 and a second side substrate 53. Particularly, the first side substrate 52 and the second side substrate 53 are substantially provided in parallel with each other, and the bottom substrate 51 connects the first side substrate 52 and the second side substrate 53. Electrical connection terminals for connecting external power and signals may be connected to any part of the bottom substrate 51, the first side substrate 52, and the second side substrate 53, thereby achieving circuit signal connectivity.

In some alternative examples, the first driving coil 2411 for driving the first driving portion 24 of the light steering assembly 20 and the Y-axis sensing element 272 are provided at the inner surface of the bottom substrate 51. The second driving coil 2421 for driving the first driving portion 24 of the light steering assembly 20 and the X-axis sensing element 271 are provided at the inner surfaces of the first side substrate 52 and the second side substrate 53. The third driving coil 3311 for driving the second driving portion 33 of the lens assembly 30 is provided at inner surfaces of the first side substrate 52 and the second side substrate 53.

Particularly, the main circuit board 50 is provided at the outside of the base 11, and can be integrally connected; alternatively, the circuit boards installed with various driving coils may be separately provided.

Referring to FIGS. 1-2, the photosensitive assembly 40 is provided in the internal space of the housing 10, and is provided in the photosensitive assembly installation area 116. The photosensitive assembly 40 comprises a circuit board 41, a photosensitive element 42 and a filter element 43. Particularly, the photosensitive element 42 is conductively connected to the circuit board 41, and the filter element 43 is provided at the photosensitive path of the photosensitive assembly 40, so that the light entering the photosensitive assembly 40 from the lens assembly 30 is filtered after passing through the filter element 43, and reaches the photosensitive element 42 to be received for imaging. The filter element 43 may be provided in the housing 10 or on the photosensitive element 42.

When the camera module 1 is installed in an electronic device, the optical axis direction (Z axis) of the lens assembly 20 in the camera module 1 is consistent with the length direction or width direction of the electronic device, and the X axis direction is consistent with the thickness direction of the electronic device terminal. The periscope camera module is installed in the electronic device without increasing the thickness of the electronic device, thereby realizing the lightweight and miniaturization of the electronic device terminal.

Those skilled in the art should understand that, the embodiments of the present application described above and shown in the accompanying drawings are only for illustrative purposes and are not intended to limit the present application. The objects of the present application have been fully and effectively achieved. The functions and structural principles of the present application have been demonstrated and described in the embodiments. Without departing from the principles, the embodiments of the present application may have any variations or modifications.

1. A light steering assembly for optical image stabilization comprising:
a base having a base bottom surface;
a first supporting mechanism supported on the base bottom surface;
a second supporting mechanism supporting a reflecting member and provided on the first supporting mechanism; and
a first driving portion comprising a first driving assembly and a second driving assembly, wherein the second driving assembly drives the second supporting mechanism and the components supported by it to rotate around a first rotation axis, and the first driving assembly is used to drive the first supporting mechanism and the components supported by it to rotate around a second rotation axis;
a magnetic attraction assembly comprising at least one first magnetic attraction member and at least one second magnetic attraction member, wherein the first magnetic attraction member is provided at the base bottom surface, and the second magnetic attraction member is provided at the second supporting mechanism;
wherein the first driving assembly comprises at least one first driving magnet provided at the first supporting mechanism, and the first magnetic attraction member and the second magnetic attraction member are respectively provided at the upper and lower side surfaces of the first driving magnet.

2. The light steering assembly according to claim 1, wherein the first driving assembly comprises at least one first driving coil, and the first driving coil is provided between the first magnetic attraction member and the first driving magnet and is opposite to the first driving magnet, to drive the first supporting mechanism and the components supported by it to rotate around the second rotation axis.

3. The light steering assembly according to claim 2, wherein the second magnetic attraction member is provided at the lower side surface of the second supporting mechanism and is opposite to the first driving magnet.

4. The light steering assembly according to claim 3, wherein the second driving assembly comprises at least one second driving magnet and a second driving coil which are provided at a side surface of the second supporting mechanism, to drive the second supporting mechanism and the components supported by it to rotate around the first rotation axis.

5. According to the light steering assembly according to claim 4, wherein it further comprises an anti-shake holding assembly, and the anti-shake holding assembly comprises a first holding element and a second holding element which are respectively provided at the upper and lower side surfaces of the first supporting mechanism.

6. According to the light steering assembly according to claim 5, wherein the first supporting mechanism is movably supported on the base bottom surface by the first holding element, and the second supporting mechanism is movably supported on the first supporting mechanism by the second holding element, and the attraction between the first magnetic attraction member and the first driving magnet clamps the first holding element, and the first holding element is held between the base bottom surface and the first supporting mechanism, and the attraction between the second magnetic attraction member and the first driving magnet clamps the second holding element, and the second holding element is held between the first supporting mechanism and the second supporting mechanism.

7. The light steering assembly according to claim 6, wherein at least one of the first supporting mechanism and the base bottom surface is provided with a groove to accommodate the first holding element, and the first supporting mechanism and other components supported by it rotate around the second rotation axis under the guidance of the first holding element and the groove.

8. The light steering assembly according to claim 7, wherein at least one first groove is provided on the base bottom surface, and at least one second groove is provided on the lower side surface of the first supporting mechanism, and at least one of the first groove and the second groove is configured to have a groove shape that is compatible with the first holding element in a cross section perpendicular to the second rotation axis, so that the first holding element rolls in situ around the second rotation axis in the first groove or the second groove.

9. The light steering assembly according to claim 8, wherein at least one of the first supporting mechanism and the second supporting mechanism is provided with a groove to accommodate the second holding element, and the second supporting mechanism and other components supported by it perform planar rotational motion around the first rotation axis under the guidance of the second holding element and the groove.

10. The light steering assembly according to claim 9, wherein the upper side surface of the first supporting mechanism is provided with at least one third groove, and the lower side surface of the second supporting mechanism is provided with at least one fourth groove, and at least one of the third groove and the fourth groove is configured to have a groove shape extending around the first rotation axis or a groove shape extending along an optical axis and being in a cross section perpendicular to the optical axis, and the optical axis is perpendicular to the first rotation axis and the second rotation axis.

11. An optical system comprising:
a base comprising a base side wall and a base bottom surface;
a light steering assembly comprising a reflective member for changing an optical path, wherein a light emergent surface of the reflective member defines an optical axis;
a lens assembly provided at the light emergent side of the light steering assembly, wherein the lens assembly comprises at least one lens portion, a lens carrier and a second driving portion, and the lens portion is provided in the lens carrier, and the second driving portion drives the lens carrier to drive the lens portion to move along the optical axis direction;
wherein the second driving portion comprises at least one third driving magnet, and the third driving magnet is provided at both sides of the lens carrier; and
wherein the lens assembly further comprises at least one magnetic conductive sheet and at least one magnetic attraction assembly, and the magnetic conductive sheet is provided at the lens carrier, and the magnetic attraction assembly is provided at the base bottom surface, and a part of the magnetic conductive sheet is opposite to the third driving magnet and is located in the magnetic field of the third driving magnet, and a part of it is provided opposite to the magnetic attraction assembly.

12. The optical system according to claim 11, wherein the second driving portion further comprises at least one third driving coil, and the third driving magnet is provided at both side surfaces of the lens carrier, and the third driving coil is provided opposite to the third driving magnet.

13. The optical system according to claim 12, wherein the lens assembly further comprises at least one third holding element, wherein the lens carrier is movably mounted in the base by the third holding element to support part or all of the lens portion.

14. The optical system according to claim 13, wherein the third holding element is provided between the lens carrier and the base bottom surface.

15. The optical system according to claim 14, wherein at least one of the lens carrier and the base bottom surface is provided with a groove to accommodate the third holding element.

16. The optical system according to claim 15, wherein the magnetic conductive sheet is located in the magnetic field of the third driving magnet to be magnetized by the magnetic field, and the lens carrier and the base bottom surface clamp the third holding element through the attraction between the magnetic conductive sheet and the magnetic attraction assembly.

17. The optical system according to claim 16, wherein the magnetic conductive sheet comprises a main body, a first side wall and a second side wall, and the first side wall and the second side wall are respectively provided at both sides of the main body and can be formed by an integrally molded metal material.

18. The optical system according to claim 17, wherein the first side wall and the second side wall are provided at a side of the third driving magnet mounted on the lens carrier facing away from the third driving coil, and the magnetic conductive sheet is magnetized by the magnetic field of the third driving magnet.

19. The optical system according to claim 18, wherein the main body of the magnetic conductive sheet is provided opposite to the magnetic attraction assembly disposed on the base bottom surface, and the generated attraction presses the lens carrier toward the base bottom surface.

20. The optical system according to claim 10, wherein in the horizontal direction, the magnetic attraction assembly is offset from the third driving magnet, and is offset from the third holding element.

21-30. (canceled)
